(19) United States
(12) Patent Application Publication
(10) Pub. No.: US 2007/0127453 A1
(43) Pub. Date: Jun. 7, 2007

(54) Server apparatus and telephone terminal

(76) Inventor: Tsutomu Shibata, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/600,777

(22) Filed: Nov. 17, 2006

(30) Foreign Application Priority Data
Nov. 21, 2005 (JP) 2005-336204

(51) Int. Cl. H04L 12/66

(52) U.S. Cl. 370/356

(57) ABSTRACT

According to one embodiment, a server apparatus includes an acquiring unit to acquire level information showing the security levels from a first and a second telephone terminals among the plurality of telephone terminals in communication-connecting between the first and the second telephone terminals, and a notifying unit to notify each security level to the first and the second telephone terminals based on the acquired level information.

### CROSS-REFERENCE TO RELATED APPLICATIONS

This application is based upon and claims the benefit of priority from Japanese Patent Application No. 2005-336204, filed Nov. 21, 2005, the entire contents of which are incorporated herein by reference.

### BACKGROUND

1. Field

One embodiment of the invention relates to a server apparatus and a telephone terminal in a telephone system, for instance, an Internet protocol (IP) telephone system and the like, which makes voice communications among telephone terminals via an IP network.

2. Description of the Related Art

In recent years, a network telephone system, interactively transferring images and voices as packet data in real time via a packet network, has begun to prevail.

The IP telephone system connects IP telephone terminals, for instance, to a Local area network (LAN), connects the LAN to a general telephone network and the Internet via a gateway, and performs protocol conversions and format conversions of data, etc., by means of the IP telephone terminals and the gateway. Thereby, the IP telephone system enables voice communications among the IP telephone terminals with one another, and among the IP telephone terminals and the general telephone network or the Internet (for example, refer to Jpn. Pat. Appln. KOKAI Re-Publication No. 98-058475).

However, the IP telephone system usually having performed a simple encryption processing and an authentication processing, the security on the LAN or the Internet is not sufficient as matters now stand.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view depicting an IP telephone system regarding a first embodiment of the present invention;

FIG. 2 is an exemplary block diagram depicting a functional configuration of an exchange server in the first embodiment of the present invention;

FIG. 3 is an exemplary block diagram depicting a functional configuration of a terminal in the first embodiment of the present invention;

FIG. 4 is an exemplary sequence view depicting operations when security levels are notified to terminals in performing communications among the terminals in the first embodiment of the present invention; and

FIG. 5 is an exemplary flowchart depicting control processing procedures of an exchange server in notifying security levels in a second embodiment of the present invention.

### DETAILED DESCRIPTION

Various embodiments according to the invention will be described hereinafter with reference to the accompanying drawings. In general, according to one embodiment of the invention, a server apparatus which houses a plurality of telephone terminals differing in security levels for communications from one another via a communication network and connects among the plurality of telephone terminals to perform the communications of media information, comprising: an acquiring unit to acquire level information showing the security levels from a first and a second telephone terminals among the plurality of telephone terminals in communication-connecting between the first and the second telephone terminals; and a notifying unit to notify each security level to the first and the second telephone terminals based on the acquired level information.

### FIRST EMBODIMENT

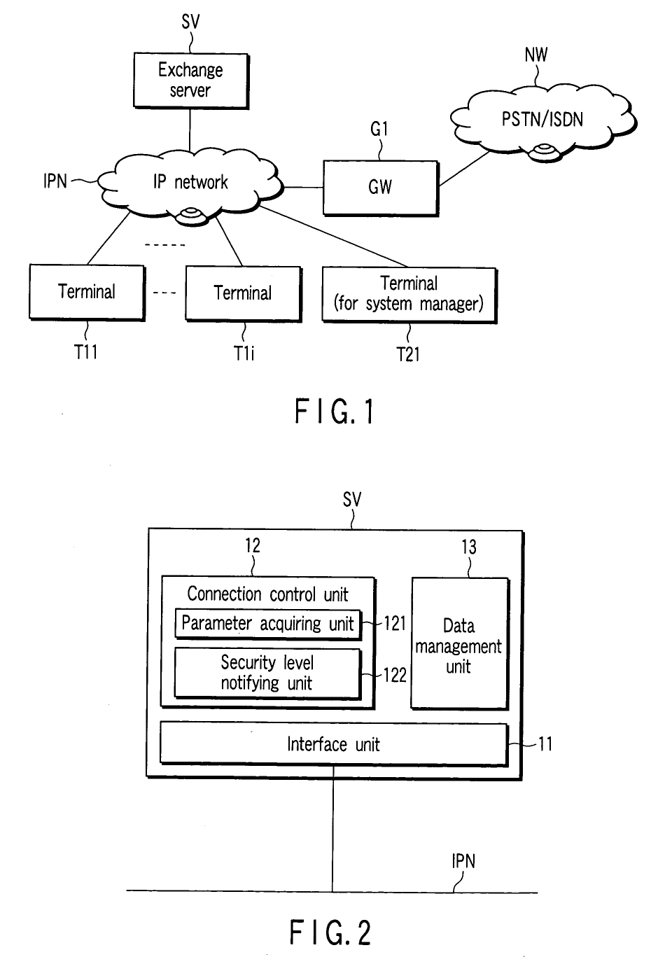

FIG. 1 is a schematic configuration view showing an IP telephone system regarding a first embodiment of the present invention.

The telephone system has an IP network IPN consisting of the Internet and a LAN for a packet communication. The IP network IPN connects terminals T11-T1i (i is natural number) and a terminal 21 for a system manager, as telephone terminals. The terminals T11-T1i and the T21 are IP telephone terminals each equipped with communication processing functions and media information processing functions.

A gateway G1 is connected to the IP network IPN. The gateway G1 connects between the IP network IPN and a public network (PSTN/ISDN) NW and includes a conversion function of communication protocols and signal formats between the IP network IPN and the public network NW.

Further, an exchange server SV is connected to the IP network IPN. The exchange server SV has an exchange control function for the terminals T11-T1i, T21 and the gateway G1.

Meanwhile, the forgoing exchange server SV has the following functions as functions regarding the present invention. FIG. 2 is a block diagram showing the configuration of the exchange server SV.

The exchange server SV has an interface unit 11, a connection control unit 12 and a data management unit 13. Among them, the interface unit 11 conducts an interface processing to and from the IP network IPN.

The connection control unit 12 performs connection control to and from the IP network IPN, and for instance, connects a terminal T12 to be an incoming destination in response to a transmission from a terminal T11 on the IP network IPN.

The data control unit 13 stores routing information, etc., necessary for the connection control by the control unit 12. The management unit 13 registers IP addresses or telephone numbers of the terminals T11-T1i and T21 that become connection objects. Furthermore, the management unit 13 registers character data and image information relating to security levels.

By the way, in the first embodiment, the control unit 12 includes a parameter acquiring unit 121 and a security level notifying unit 122. The acquiring unit 121 receives a proposal voice parameter transmitted from the terminal T11 to be an outgoing side together with an outgoing request and receives a proposal voice parameter transmitted from the terminal T12 in response to the outgoing request, for instance, in communication-connecting to the terminals T11 and T12. The proposal voice parameter includes each security level of the terminals T11 and T12.

The notifying unit 122 notifies the security levels included in the voice parameter to the terminals T11 and T12. In the notification, the notifying unit 122 notifies the character data or the image information stored in the management unit 13 to the terminals T11 and T12.

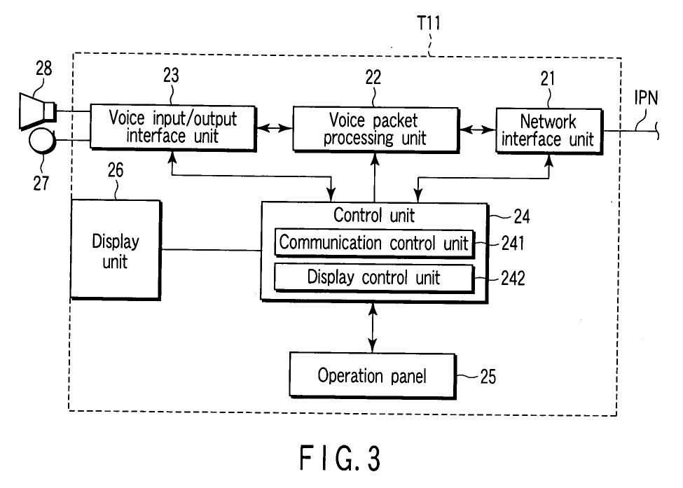

On the other hand, the terminals T11-T1i are configured as follows. FIG. 3 is a block diagram showing the configuration. Here, the terminal T11 will be described on behalf of the terminals T11-T1i.

The terminal T11 includes a network interface unit 21 (hereinafter, referred to as interface unit 21). A voice packet processing unit 22 (hereinafter, referred to as processing unit 22), a voice input/output interface unit 23 (hereinafter, referred to as interface unit 23), a control unit 24, an operation panel 25, and a display unit 26.

The interface unit 21 conducts an interface operation relating to the IP network IPN. The interface unit 21, namely, extracts a voice packet and control data from a transmission packet transmitted from the IP network IPN to transfer the voice packet to the processing unit 22 and the control data to the control unit 24. The interface unit 21 transmits the voice packet supplied from the interface unit 21 and the control data supplied from the control unit 24 to the IP network IPN.

The processing unit 22 converts the voice packet transferred from the interface unit 21 into an analog reception voice signal to supply it to the interface unit 23. The processing unit 22 converts a transmission voice signal input from the interface unit 23 into a voice packet capable of dealing with in the IP network IPN to transfer it to the interface unit 21.

A microphone 27 and a loud-speaker 28 are connected to the interface unit 23. The interface unit 23 inputs the transmission voice signal input through the microphone 27 to the processing unit 22 and also loud-outputs the reception voice signal output from the processing unit 22 through the loud-speaker 28.

The control unit 24 conducts control of each unit of the terminal T11 and a communication processing to and from the IP network IPN though a software processing.

The operation panel 25 has key switches to receive a variety of instruction inputs from the user to the control unit 24.

The display unit 26 has a liquid crystal display (LCD), etc., and performs a variety of information notifications to the user.

Meanwhile, in the first embodiment, the control unit 24 has a communication control unit 241 and a display control unit 242. When making an outgoing call, the control unit 241 transmits the proposal voice parameter including a self security level together with the outgoing request, and also receives the character data or the image information showing security levels to be transmitted by the exchange server SV in response to the proposal voice parameter.

When receiving the character data or the image information showing the security levels from the exchange server SV, the control unit 242 displays the character data or the image information onto the display unit 26. The control unit 242 may use turning on a light, or blinking on and off the light, and emitted light color of a light emitting diode (LED), etc.

Next, operations of the telephone system configured as described above will be set forth.

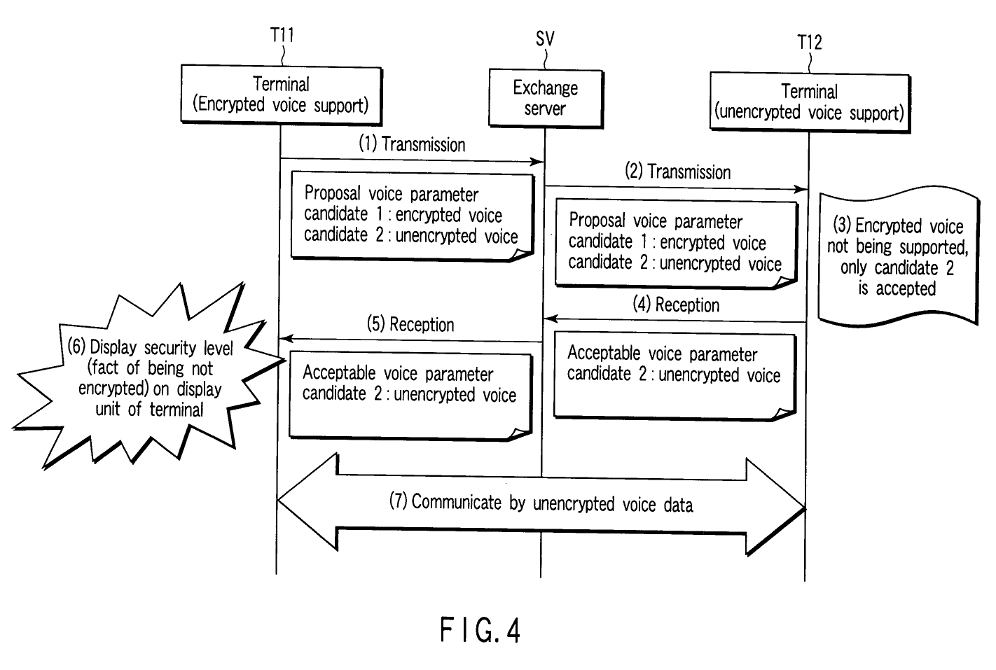

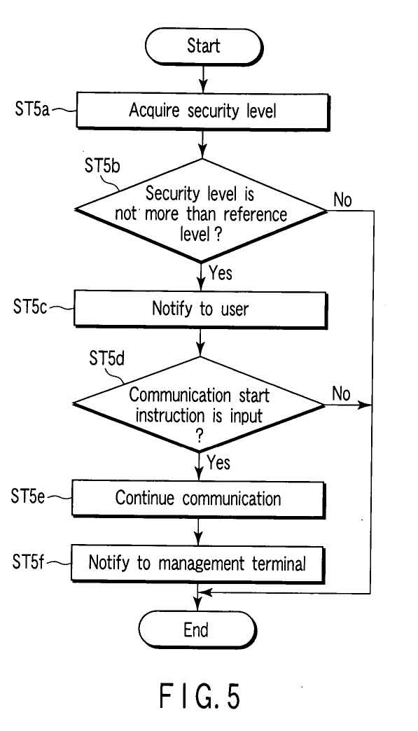

FIG. 4 is a sequence view showing operations when security levels are notified to the terminal T11 in making communications between the terminal T11 and the terminal T12.

It is supposed that, for instance, in the terminal T11, the user conducts an outgoing operation to the terminal T12. The terminal T11 then transmits an outgoing message to the exchange server SV. The outgoing message includes a destination parameter and a proposal vice parameter consisting of a plurality of candidates.

The exchange server SV decides a connection destination from the destination parameter included in the outgoing message to transmit the outgoing message to the terminal T12.

The terminal T12 decides a candidate of the proposal voice parameter included in the received outgoing message and a candidate capable of accepting depending on a capability of its own device. Here, the terminal T12 decides to accept only an unencrypted voice of a candidate 2 because the terminal T12 does not support an encryption function.

The terminal T12 returns the reception message including the accepting voice parameter consisting of the decided candidate 2.

The exchange server SV returns the reception message including the character data showing the candidate 2 to the terminal T11.

The terminal T11 decides to use the unencrypted voice of the candidate 2 in accordance with the accepting voice parameter included in the received reception message for the purpose of communications with the terminal T12. The terminal T11 then displays that voice information is an unencrypted voice (in danger of being listened in) as a security level display onto the display unit 26. On the contrary, when encryption is effective, the terminal T11 displays an encrypted icon (image information), an encryption method and a key length (for example, key mark, SSL, 128).

The terminal T11 then uses the unencrypted voice of the candidate 2 to begin the communications with the terminal T11.

In the first embodiment, having described about an example to display the security levels onto the terminal T11 in the case of outgoing from the terminal T11, even the terminal T11 receives an incoming call, the security levels are displayed on the terminal T11 similarly. Both terminals T11 and T12 communicated with each other being extension terminals housed in the exchange server SV, the displays of the security levels may be displayed on both terminals T11 and T12.

As mentioned above, in the first embodiment, in communication-connecting between the terminals T11 and T12, before starting the communications, the terminal T11 to be the outgoing origin notifies the voice parameter including the candidates of the security levels to the exchange server SV. Then, the exchange server SV notifies the voice parameter to the terminal T12 to be the incoming destination to acquire the security level from the terminal T12 and notifies the security level to the terminal T11.

Accordingly, the user of the terminal T11 can recognize the security level of the terminal T12 before starting the communications therewith. Thereby, the user can communicate in response to the security levels and greatly improve the convenience of the user itself.

In the aforementioned first embodiment, displaying the character data relating the security level of the terminal T12 to be a communication partner onto the display unit 26, the user of the terminal T11 can easily determine the security level by watching the display unit 26.

### SECOND EMBODIMENT

FIG. 5 is a flowchart in a second embodiment of the present invention showing the control processing procedures of the exchange server SV. Here, in communicating between the terminal T11 and a terminal T13, a security level indicating a numeric value results in the notification to the exchange server SV.

For instance, it is presumed that, in the terminal T11, the user conducts an outgoing operation to the terminal T13. The terminal T11 then transmits an outgoing message to the exchange server SV. The outgoing message includes a proposal voice parameter consisting of a destination parameter and a security level “5” of itself.

The exchange server SV then acquires the security level “5” from the voice parameter (block ST5a) to determine whether or not the security level is not more than reference level “3” (block ST5b). Here, the security level being higher than the reference level, the exchange server continues processings as they are.

The exchange server SV then acquires a security level “2” from the terminal T13 to be the incoming destination. In this case, the security level being equal to the reference level or below, the exchange server SV notifies the message showing the danger of being listened in to the terminals T11 and T13 together with the security level “2” to display them on the display unit 26 (block ST5c).

In this situation, it is supposed that the users of the terminals T11 and T13 input communication start instructions by means of the operation panel 25 so as to start communications. The exchange server SV then sifts from the block ST5d to a block ST5e, here, it performs a communication connection between the terminal T11 and T13 to continue the communications, and after this, it notifies a message showing the fact of the continuation of the communications in the security level “2” with the terminal T13 to the management terminal T21 (block ST5f).

In the block ST5d, if the user does not input the communication start instruction within a fixed time interval, the exchange server SV terminates the processings.

In the block ST5b, the exchange server SV may notify the fact to the terminal T21 at the time when the security level becomes equal to or lower than the reference level.

As given above, the second embodiment in the present invention, the exchange server SV having notified the fact at every time when the security levels acquired from each terminal T11 and T13 become lower than the preset reference level, the user of the terminal T11 and T13 may determine to instruct whether the users themselves have to perform communications. Thereby, the users become possible to only make communications which are really needed.

In the second embodiment, the exchange server SV having notified the fact to the management terminal 21 at every time when the security level is lowered than the reference level, the telephone system may intensively manage the terminal 13 with a low security level by means of the management terminal 21.

### OTHER EMBODIMENT

The present invention is not limited to the aforementioned embodiments. The first embodiment having described the example to notify the encryption/non-encryption of the media information such as a video and a voice, it is acceptable to notify the encryption/non-encryption of the control information such as an outgoing message and a reception message.

While the first embodiment has described about the example to notify the security levels through the character data or the image information to the display unit, notifying the security levels through tone and voice guidance is a possible approach.

Further, in the first embodiment, although the example in which the terminal on the outgoing side autonomously transmits the proposal voice parameter, the terminal may transmit the proposal voice parameter including the security levels in response to the request from the exchange server SV.

Other than this, the configuration of the telephone system, the configuration of the server device such as an exchange server, the configurations of the terminals, communication control procedures and the contents of the security levels may also implemented with a variety of modifications within the principle of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which houses a plurality of telephone terminals differing in security levels for communications from one another via a communication network and connects among the plurality of telephone terminals to perform the communications of media information, comprising:
an acquiring unit to acquire level information showing the security levels from a first and a second telephone terminals among the plurality of telephone terminals in communication-connecting between the first and the second telephone terminals; and
a notifying unit to notify each security level to the first and the second telephone terminals based on the acquired level information.

2. The server apparatus according to claim 1, when the first and the second telephone terminals each have display units,
wherein the notifying unit displays characters or image information showing the security levels onto each display unit of the first and the second telephone terminals.

3. The server apparatus according to claim 2, wherein the notifying unit notifies the security levels by means of at least one of turning on lights, turning off the lights, blinking on and off the lights and emitted light colors of each of the display units of the first and the second telephone terminals.

4. The server apparatus according to claim 1, wherein the notifying unit notifies each security level to the first and the second telephone terminals by means of tone or voice guidance.

5. The server apparatus according to claim 1, wherein the notifying unit notifies the security levels to the first and the second telephone terminals, when the security levels each acquired from the first and the second telephone terminals are lower than a preset security level.

6. The server apparatus according to claim 1, wherein the notifying unit notifies the security levels to the first and the second telephone terminals when the security levels each acquired from the first and the second telephone terminals are lower than a preset security level, and continues communications when a user inputs a continuation instruction of the communications in response to the notification.

7. The server apparatus according to claim 1, wherein the notifying unit notifies at least one of a presence or absence of encryption, a presence or absence of authentication of the media information, and an encryption intensity if the media information are encrypted, as the security levels to the first and the second telephone terminals.

8. The server apparatus according to claim 1, wherein the notifying unit notifies at least one of a presence or absence of encryption, a presence or absence of authentication of a part of items of control information necessary for communication-connecting between the first and the second telephone terminals, and an encryption intensity if the media information are encrypted, as the security levels to the first and the second telephone terminals

9. The server apparatus according to claim 5, when a management terminal is connected to the communication network, wherein the notifying unit notifies the security levels each acquired from the first and the second telephone terminals to the management terminal when the security levels are lower than a preset security level.

10. The server apparatus according to claim 6, when a management terminal is connected to the communication network, wherein the notifying unit notifies the security levels to the first and the second telephone terminals when the security levels each acquired from the first and the second telephone terminals are lower than a preset security level, and continues communications when a user inputs a continuation instruction of the communications in response to the notification to notify the fact of the communication continuation to the management terminal.

11. A telephone terminal connected a server apparatus via a communication network, the server apparatus connects among a plurality of telephone terminals to perform the communications of media information, comprising:
a transmitter which transmits notification requests for a security levels of communication partners to the server apparatus in communication-connecting; and
a notifying unit to notify the security levels of the communication partners notified from the server apparatus in response to the notification requests for the security levels to a user.
